(19) United States
(12) Patent Application Publication
(10) Pub. No.: US 2017/0045837 A1
(43) Pub. Date: Feb. 16, 2017

(54) Polymer/Carbon Black Composite: Method for Its Preparation and Use Thereof

(71) Applicant: King Abdulaziz City for Science and Technology, Riyadh (SA)

(72) Inventors: AHMED ALI BASFAR, RIYADH (SA); Klaus Jähnichen, Dresden (DE); Brigitte Voit, Dresden (DE)

(21) Appl. No.: 14/953,303

(22) Filed: Nov. 28, 2015

Related U.S. Application Data
(63) Continuation-in-part of application No. 14/827,274, filed on Aug. 15, 2015.

(51) Int. Cl. G03G 9/09; G03G 9/097; G03G 9/08

(52) U.S. Cl. CPC G03G 9/0904; G03G 9/0806; G03G 9/09783

(57) ABSTRACT

There is provided a process for preparing a polymer/carbon black composite material. The process comprises a mini emulsion polymerization (MEP) process involving a reactive co-stabilizer. Optionally, the co-stabilizer is a long alkyl chain methacrylate or a mixture of long alkyl chain methacrylates.

### CROSS REFERENCE TO RELATED APPLICATION

This application claims priority to U.S. patent application Ser. No. 14/827,274 filed on Aug. 15, 2015. The pending application Ser. No. 14/827,274 is hereby incorporated by reference in its entireties for all of its teachings.

### FIELD OF TECHNOLOGY

This invention relates generally to polymer/carbon black composites. More specifically, this invention relates to a mini emulsion polymerization (MEP) process for preparing a polymer/carbon black composite material. The composite material of the invention may be used in various applications including toner applications.

### BACKGROUND

Mini emulsion polymerization (MEP) was first reported nearly 40 years ago (Ugelstad et al., 1974). In this technique, a co-stabilizer, sometimes called “hydrophobe”, is used to retard the diffusion of monomer molecules from smaller droplets to larger ones (Ostwald ripening effect). Kinetically stable small monomer droplets are formed in the presence of the co-stabilizer and the polymerization process takes place in these droplets. Using this technique, it is possible to polymerize water insoluble monomers, because there is no need to diffuse from the monomer droplets to the micelles such as in emulsion polymerization. Typically in MEP, a droplet nucleation dominates. This means that polymerization takes place inside the monomer droplets such as in suspension polymerization. Consequence, materials with small particles sizes (<500 nm) may be obtained by mini emulsion polymerization. This technique is described in several reviews by Landfester et al. (Landfester et al., 2003; Guyut et al., 2007; Landfester et al., 2009; Weiss et al., 2010; Landfester et al., 2010).

Generally in MEP, hydrophobic hexadecane (HD) is used as co-stabilizer. Other substances have also been used. Crespy and Landfester (2010) provide an overview of the various co-stabilizers used.

Chern et al. (1997) reported the use, as co-stabilizer in MEP, of long chain alkyl methacrylates together with different ionic (sodium dodecyl sulfate, SDS) or non-ionic surfactants (ethoxylated fatty alcohols or ethoxylated alkyl phenols). They found that stearyl methacrylate (SteaMA) was more efficient than dodecyl methacrylate (DMA), because of the difference in the water solubility of the monomer. A further advantage they reported with SteaMA was the incorporation of the hydrophobic substance into the polymer chain. Chem et al. also reported that the use of DMA resulted in dispersions with a broader particle size distribution then SteaMA. Beside SDS as surfactant, nonionic surfactants based on ethoxylated fatty alcohols were also investigated. SteaMA was also used for the mini emulsion polymerization of methyl methacrylate (MMA). Other hydrophobic substances including cyclic siloxanes and olive oil were investigated as co-stabilizer in MEP (Bechthold, 2000; Landfester and Bechthold, 1999).

Further possibilities of polymerizable hydrophobic substances that would be used as co-stabilzers in MEP include acrylated plant oils. For example, commercially available acrylated linseed oil (Mercryl LS, LT) and acrylated soy bean oil (Photomer 3005F). Bunker et al. (2006) reported the mini emulsion polymerization of acrylated methyl oleates for pressure sensitive adhesives. No extra hydrophobic co-stabilizer was added to the mini emulsion. While the mini emulsion polymerization of the monomer showed a complete conversion even after lh, the conventional emulsion polymerization took 18 h until complete conversion. Furthermore, the amount of surfactant could be reduced from 15 wt % to 2 wt %.

### Preparation of Carbon Black Composites Using MEP Technique

Lanfester et al. (2000) described the encapsulation of CB using the MEP technique. They found that the co-stabilizer played an important role in the encapsulation process. Not only did the co-stabilizer suppress the Ostwald ripening, it also covered the surface of CB to prevent the formation of larger aggregates. CB was sonicated together with the organic phase in the first step. Later, water and SDS were added and the sonication was repeated. Particles of 100-150 nm size were formed. CB could only be detected by TEM after the melting of the particles. After aging the particles at 120° C., aggregates of CB in the size of about 30-100 nm were detected. The latexes were analyzed by ultracentrifugation in a density gradient which was realized by different sucrose solutions. Unmodified CB could not be observed in any experiments. But it could be shown that CB was not homogeneously distributed within the PSt. Furthermore, often pure PSt was also observed. The outcome of the encapsulation process was greatly influenced by the nature of the co-stabilizer. Up to a maximum of 8 wt % CB could be encapsulated with this method.

Landfester et al. (2001) reported the encapsulation of a relatively large amount of CB using a further developed two-step mini emulsion technique. Up to 80 wt % of CB may be encapsulated using this technique. It was first described to prepare a stable dispersion of CB in water using surfactants such as SDS (e.g. 15 wt % based on CB). The resulting particle size of the CB was about 90-140 nm. In a second part, a normal MEP recipe for the polymerization of St was used to prepare a mini emulsion containing St and SDS. A custom-made polyurethane was preferentially used as co-stabilizer in these experiments. This special co-stabilizer showed good interactions with the CB surface and was closely adsorbed at the CB surface. Finally, the formed mini emulsion of St and the (stable) CB dispersion were mixed together in the appropriate amount and sonicated. Polymerization particles with a size between 70-90 nm were obtained. This is in the range of the covalently linked CB clusters. Non-spherical particles were formed with a top layer of PSt (TEM). The application of this encapsulation technique was limited to only relatively high amounts of CB in the mixture. This process is not a MEP but a polymerization in an adsorbed monomer layer which was created and stabilized as a mini emulsion (role of co-stabilizer) (Landfester et al., 2001).

Han et al. (2010) described an encapsulation process of CB by polystyrene using the mini emulsion approach. First, a surface modification of CB was performed, by an oxidation process with KMnO₄. Then the OH groups formed were converted into esters by reaction with oleic acid. The so-modified CB was used in encapsulation processes by the mini emulsion technique. A stable dispersion of the modified CB was realized by sonication process, in the presence of water/SDS/HD. The success of the encapsulation process was enhanced by increasing the ratio CB:St from 1:1 up to 5:1. Samples with high amounts of styrene showed that the excess of St formed pure PSt without any CB. The drawback from a practical point of view was the preparative effort of the surface modification of CB, especially the esterification of the OH groups with oleic acid and the extraction of unreacted oleic acid as purification step. A 5-fold excess of oleic acid based on the generated OH groups was the optimum for the esterification reaction.

There is a need for improved MEP processes. Particularly, there is a need for improved MEP processes for preparing composites comprising carbon black.

### SUMMARY

This disclosure is drawn to a mini emulsion polymerization (MEP) process for preparing a polymer/carbon black composite material. The process involves a reactive hydrophobic co-stabilizer. The composite material of the invention may be used in various applications. Such applications include for example applications where it is desired to have a material with low volatile organic content (VOC), such as for example toners, coatings, and ingredients in polymer blends.

In toner applications, the polymer/carbon black composite material of the invention leads to a reduction in VOC. Accordingly, the composite material of the invention is environmentally friendly and potentially less harmful for the health.

The polymer/carbon black composite material may also be useful in applications wherein it is desired to have material with low T_{g}.

The reactive hydrophobic co-stabilizer used in the process of the invention is polymerizable. It may be for example a long alkyl chain methacrylate or a mixture of such methacrylates. An example of a general chemical formula of a long alkyl chain methacrylate is depicted below (Formula I) with R being a C₆ to C₂₂ linear, branched, saturated or unsaturated alkyl group. An example of such long chain methacrylate is stearyl methacrylate (SteaMA), the chemical formula of which is also depicted below (Formula II).

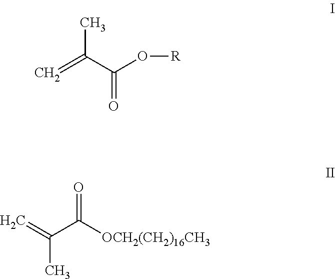

The co-stabilizer of the invention allows for an adjustment of the glass transition temperature (Tg) of the composite material obtained. Indeed, the co-stabilizer is covalently incorporated into the polymeric matrix through copolymerization.

Several embodiments for the process and material of the invention are outlined below

The invention provides, according to an aspect, for a process for preparing a polymer/carbon black composite material, comprising a mini emulsion polymerization (MEP) process involving a reactive co-stabilizer.

In one embodiment, the co-stabilizer is a long alkyl chain methacrylate or a mixture of long alkyl chain methacrylates.

In one embodiment, the co-stabilizer is a long alkyl chain methacrylate of general formula I below

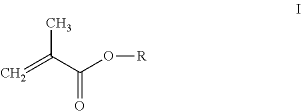

wherein R is a C₆ to C₂₂ linear, branched, saturated or unsaturated alkyl group, or the co-stabilizer is a mixture of two or more of the long alkyl chain methacrylates.

In one embodiment, the co-stabilizer is a long alkyl chain methacrylate of general formula I below

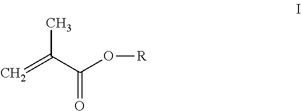

wherein R is a C₁₀ to C₂₀ linear, branched, saturated or unsaturated alkyl group, or the co-stabilizer is a mixture of two or more of the long alkyl chain methacrylates.

In one embodiment, the co-stabilizer is stearyl methacrylate (SteaMA) of formula II below

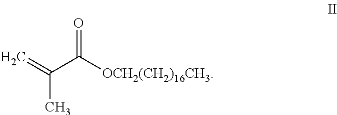

In one embodiment, the MEP process further involves monomers of one type or more and carbon black.

In one embodiment, the MEP process further involves monomers of one type or more, carbon black and a charge control agent.

In one embodiment, the MEP process further involves monomers of one type or more and carbon black, and wherein the monomers are selected from the group consisting of styrene (St), alkyl esters of acrylic and methacrylic acids, vinyl esters of aliphatic acids, and monomers containing sulfonate groups including sodium styrene sulfonate (NaSS).

In one embodiment, the MEP process further involves styrene (St) monomers and carbon black.

In one embodiment, the MEP process further involves styrene (St) monomers, carbon black and a charge control agent.

In one embodiment, the amount of co-stabilizer is about 0.5 to 15 mol % based on the amount of the monomers.

In one embodiment, the MEP process further involves monomers of one type or more, carbon black and a charge control agent, and wherein an amount of the charge control agent is about 0.1 to 10 mol % based on the amount of the monomers.

According to another aspect, the invention provides for a polymer/carbon black composite material obtained by a mini emulsion polymerization process (MEP) involving:

a co-stabilizer which is a long alkyl chain methacrylate of general formula I below

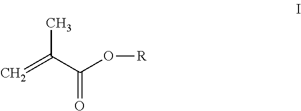

wherein R is a C₆ to C₂₂ linear, branched, saturated or unsaturated alkyl group, or
the co-stabilizer is a mixture of two or more of the long alkyl chain methacrylates; monomers of one type or more; and carbon black.

In one embodiment, the polymer/carbon black composite material further involves a charge control agent.

In one embodiment, the polymer/carbon black composite material has particles size in the range of about 20 to 1000 nm.

In one embodiment, the polymer/carbon black composite material has a carbon black content in the range of about 0.5 to 20 wt %.

According to a further aspect, the invention provides for a polystyrene/carbon black or polystyrene copolymer/carbon black obtained by a mini emulsion polymerization process (MEP) involving styrene (St) monomers, stearyl methacrylate (SteaMA) of general formula II below, and a charge control agent

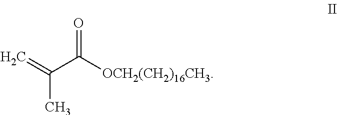

Other features will be apparent from the accompanying drawings and from the detailed description that follows.

### BRIEF DESCRIPTION OF DRAWINGS

Example embodiments are illustrated by way of example and not limitation in the figures of the accompanying drawings, in which:

FIG. 1 is a SEM picture of PSt/CB composite (5 wt % CB) using SteaMA as co-stabilizer.

FIG. 2 is a SEM picture of PSt/CB composite (8 wt % CB) using SteaMA as co-stabilier.

Other features of the present embodiments will be apparent from the accompanying drawings and from the detailed description that follows.

### DETAILED DESCRIPTION

In order to provide a clear and consistent understanding of the terms used in the present specification, a number of definitions are provided below. Moreover, unless defined otherwise, all technical and scientific terms as used herein have the same meaning as commonly understood to one of ordinary skill in the art to which this disclosure pertains.

The use of the word “a” or “an” when used in conjunction with the term “comprising” in the claims and/or the description may mean “one”, but it is also consistent with the meaning of “one or more”, “at least one”, and “one or more than one”. Similarly, the word “another” may mean at least a second or more.

As used herein, the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

As used herein, when referring to numerical values or percentages, the term “about” includes variations due to the methods used to determine the values or percentages, statistical variance and human error. Moreover, each numerical parameter in this application should at least be construed in light of the number of reported significant digits and by applying ordinary rounding techniques.

The present disclosure is drawn to a mini emulsion polymerization (MEP) process for preparing a polymer/carbon black composite material. The process involves a reactive hydrophobic co-stabilizer. The composite material of the invention may be used in various applications. Such applications include for example applications where it is desired to have a material with low volatile organic content (VOC), such as for example toners, coatings, ingredients in polymer blends.

The reactive hydrophobic co-stabilizer used in the process of the invention is polymerizable. It may be for example a long alkyl chain methacrylate or a mixture of such methacrylates. An example of a general chemical formula of a long alkyl chain methacrylate is depicted below (Formula I) wherein R is a C₆ to C₂₂ linear, branched, saturated or unsaturated alkyl group. An example of such long alkyl chain methacrylate is stearyl methacrylate (SteaMA), the chemical formula of which is also depicted below (Formula II).

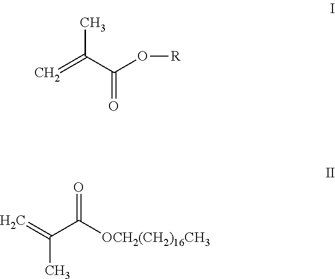

The co-stabilizer of the invention allows for an adjustment of the glass transition temperature (T_{g}) of the composite material obtained. Indeed, the co-stabilizer is covalently incorporated into the polymeric matrix through copolymerization. Accordingly, the polymer/carbon black composite material may also be useful in applications where it is desired to have a material a with low T_{g}.

Information on the various chemicals used in this invention is outlined in Table 1 below.

TABLE 1

| Chemical name | Abbreviation | CAS# | Supplier | Formula |
|---|---|---|---|---|
| Monomer | | | | |
| Styrene | St | 100-42-5 | 99% Aldrich | 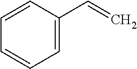 |
| Surfactant | | | | |
| Sodium dodecyl sulfate | SDS | 151-21-3 | >99% Fluka | 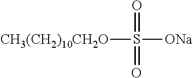 |
| Co-stabilizers | | | | |
| Hexadecane | HD | 544-76-3 | >99% | CH₃—(CH₂)₁₄—CH₃ |
| | | | Sigma- | |
| | | | Aldrich | |
| Stearyl methacrylate | SteaMA | 32360-05-7 | 95% abcr | 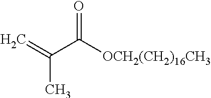 |
| Charge control agent | | | | |
| (CCA) | | | | |
| Hydroxyaluminium bis [2-hydroxy-3,5- di t-butyl salicyic acid] | MEC-88 | 65272-92-1 | Korea Material Technology | 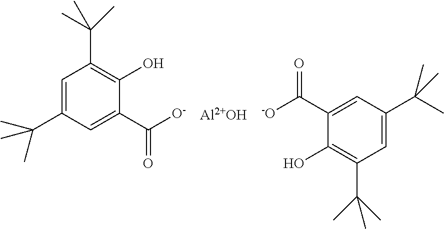 |
| Zirconium salicylate | MEC-105 | 226996-19-6 | KMT Korea Material Technology | 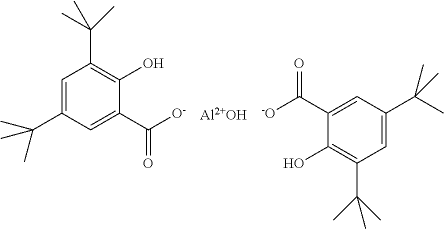 |
| Initiator | | | | |
| 2,2'-Azobis(2- methylpropionitrile) | AIBN | 78-67-1 | 98% Sigma- Aldrich | 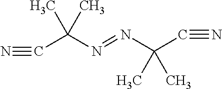 |
| Carbon Black (CB) | | | | |
| NIPex ® 35 | CB-35 | | Evonik | |
| NIPex ® 90 | CB-90 | | Evonik | |
| NIPex ® 150 | CB-150 | | Evonik | |
| Inorganic substances | | | | |
| Phosphorous pentoxide | P₄O₁₀ | 1314-56-3 | Sigma- Aldrich | 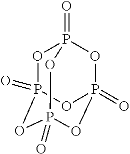 [SMILES: O=P12OP3(=O)OP(=O)(O1)OP(=O)(O2)O3] |
| Calcium hydride | CaH₂ | 7789-78-8 | Sigma- | CaH₂ |
| | | | Aldrich | |
| Sodium chloride | NaCl | 7647-14-5 | 99% Sigma- | NaCl |
| | | | Aldrich | |
| Solvents | | | | |
| Methanol | MeOH | 67-56-1 | p.A. | CH₃—OH |
| | | | ACROS | |
| Tetrahydrofuran | THF | 109-99-9 | 99.9% Sigma- Aldrich | 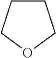 |
| Hexane | Hex | 110-54-3 | 95% Sigma- | CH₃—(CH₂)₄—CH₃ |
| | | | Aldrich | |
| Chloroform | CHCl₃ | 67-66-3 | 99% Sigma- | CHCl₃, stabilized with amylene |
| | | | Aldrich | |
| Stabilizer | | | | |
| Hydroquinone | HQ | 123-31-9 | 99% Sigma- Aldrich | 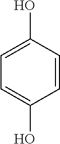 |

The MEP of hydrophobic monomers such as St with a long chain alkyl acrylate as co-stabilizer is described in the literature and may be successfully performed in the presence of SDS. As indicated above, MEP processes generally use hydrophobic hexadecane (HD) as co-stabilizer. In this invention, HD is replaced by a long chain methacrylate. The size of the particles in the composite material obtained is comparable to the size of the particles in a material obtained by a classic MEP using HD as co-stabilizer. The long chain alkyl co-stabilizer forms copolymers with styrene. Modulated DSC investigations show two T_{g} of 62 and 93° C. pointing to the existence in the particles of a copolymer as well as pure PSt. These results were found for samples with high amount of co-stabilizer such as in Examples 1 and 2 outlined below.

The T_{g} of the particles, as well as the particle size and the particle size distribution depend on the amount of reactive long alkyl chain methacrylate used.

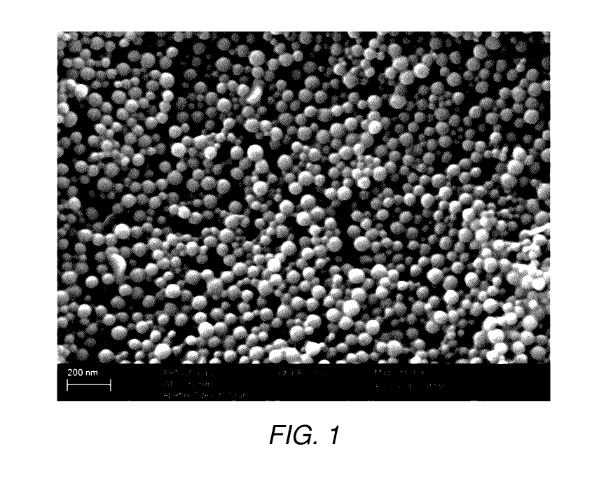

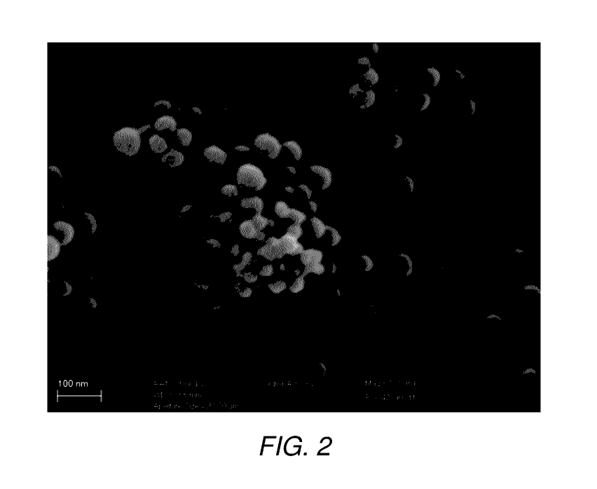

Preparation of St/CB composite particles was performed successfully in the presence of a reactive long chain alkyl methacrylate, SteaMA, as co-stabilizer. The St/CB composite particles were stable (Examples 4-10), similarly to particles in a MEP process performed in the presence of HD as co-stabilizer (Example 3). No unmodified CB was observed, as shown by scanning electron microscopy (SEM) investigations presented in FIG. 1 and FIG. 2, which relate to Examples 4 and 5, respectively.

The content of CB in the composite material varied between 5 and 10 wt %. In all cases, and using various types of CB, stable composite particles were obtained with a particle size of >90 nm and with often bimodal size distribution. High monomer conversion rates >95% were obtained and the resulting polymers showed high molar masses with Mn >100,000 g/mol.

In toner applications, it is known that charge control agents (CCAs) play an important role. Therefore, the formation of PSt/CB composites was studied in the presence of CCA. The investigated CCA were bi-salicylates of Al or Zr. The use of HD as co-stabilizer did not give positive results in the formulations. Significant amount of unmodified CB was observed by SEM. Replacement of HD by SteaMA showed an improvement in the quality of the composite particles obtained. No unmodified CB was found by SEM investigations for the two CCA types used (Examples 13 and 14). In all of the experiments a conversion rate of the monomers of >93% was obtained. Thus, the use of a reactive co-stabilizer such as SteaMA instead of HD in the MEP process for the preparation of a polymer/CB composite is advantageous.

The commonly used low molecular weight co-stabilizers such as HD or hydrophobic oils has a drawback in that such stabilizers physically bound to the products only after the polymerization reaction. Consequently, the polymeric particles obtained still contain volatile substances. Despite the fact that the boiling point of HD is relatively high, about 287° C., the thermogravimetric analysis of pure HD showed evaporation at temperatures of up to 200° C. with a Tₒₙₛₑₜ of 89° C. and T₁₀% of 133° C. (TGA under N₂, 10 K/min). Thus liberation of volatile substances cannot be excluded in applications such as printer applications where high temperatures are common. Replacing “volatile” HD with a reactive co-stabilizer reduces the VOC. The reactive co-stabilizer is incorporated by covalent bonds into the polymer chain after the polymerization thus avoiding liberation of any volatile substances.

Furthermore, the formation of copolymers resulted in products with lower T_{g} as the original PSt. A lowering of T_{g} of up to 62° C. was observed by modulated DSC for products with the highest content of SteaMA.

Furthermore, preparation of PSt/CB composite material having a CB content of up to 10 wt % is possible, and the composite material may be prepared in the presence of CCA. It was even noted that in this case, the particles presented a higher stability.

### EXAMPLES

### MEP of St using SteaMA as Co-Stabilizer

### Examples 1 and 2

Details of the experiments performed and the results of the analytical investigations are summarized in Table 2 below.

4.27 g of purified St, 0.929 g SteaMA (98%), and 0.146 g AIBN were weighted. After mixing by shaking the organic phase, the required amounts of surfactant SDS (0.056 g) and water (41.6 g) were added. Then the mixture was slowly stirred at about 150 rpm under N₂ (the needle for purging with N₂ was not in the mixture, very small stream of N₂) for 15 minutes. During this time, the SDS was dissolved in water. A formation of pre-emulsion was not observed because of the slow stifling. Then the mixture was stirred under N₂ at 800 min⁻¹ for 30 minutes to prepare the pre-emulsion using a glass stirrer. The distance between top side fastener stirrer and lower side of the fastener motor was measured and used in further experiments. So the stifling conditions were comparable.

After 30 minutes, the mixture was transferred to the sonifier. During the transfer, a moderate stream of N₂ was applied. The mini emulsion was prepared by sonication of the pre-emulsion for 600 s (level 7, pulse, duty cycle 50%) with an ultrasonic disintegrator Branson 450W using a ½″ minitip. The connection between vessel and tip was realized by a special Teflon adapter. Due to the adapter, a tight connection between minitip and vessel could be realized. During all operations the vessel was purged with a slight stream of nitrogen. A cooling of the reaction vessel by ice water was performed during the sonication in order to avoid a heating of the mixture. The reaction vessel with the formed mini emulsion was transferred to the preheated thermostat (66° C.). The reaction was performed at 400 min⁻¹ for 3 hours. Then the mixture was cooled to room temperature within 5 minutes using ice-water. Before the storage of the dispersion, about 200 mg of a 1 wt % solution of HQ in water was added and the mixture was shaken.

### Removal of Coagulum

After the polymerization, the formed dispersion was poured through a mesh (pore size 20 μm×20 μm) and then used for the analytical investigations. Finally, the rest in the mesh and the rests from the stirrer and the vessel were transferred into a frit using water. The coagulum was washed with water and dried in vacuum at room temperature in order to determine the quantity of coagulum.

### Determination of Conversion Rate

Three samples of 2 g of the formed dispersion were weighted in a petri dish and kept overnight at room temperature. The air dried products were dried in vacuum at room temperature until the weight was constant. P₄O₁₀ was used as drying agent in the vacuum oven.

### Size Exclusion Chromatography (SEC)

SEC measurements were performed with an apparatus of the Agilent Series 1100 (RI detection, 1PL_MIXED-B-LS-column [7,5×300 mm] and 10 μm PSt gel Agilent column, Chloroform 1.0 mL/min). Polystyrene was used as standard. This was the standard method for all of the samples. The samples containing CB were filtrated to remove the CB before the analysis. The error of the method is about 10%.

### Particle Size Measurement

The particle size measurements were performed with a Zetasizer NANO S (Malvern) at a fixed scattering angle of 173°. The given values are the zₐᵥₑ (intensity based). The error of the measurements is about 5%. Higher values of PDI mean that the particle size distribution becomes broader.

### Preparation of Samples for the DLS Measurements

The measurements were performed in 0.01 N NaCl solutions according to the Malvern recommendation for the measurements of latex standards. For the experiments with 20 wt % solid content, about 250 mg of the dispersion was weighted and about 20 g of 0.01 N NaCl solution was added. For the samples with lower solid content (10 or 15 wt %) the amount of NaCl solution was proportionally reduced to keep the concentration of the thinned dispersions nearly constant. The particle sizes of 3 samples were estimated, each sample was consecutively measured twice. In few cases the application of NaCl solution led to a precipitation of the dispersion. Therefore, the dispersion was thinned only with pure Millipore water.

### Scanning Electron Microscopy (SEM)

The SEM investigations were performed with an Ultra 55 plus (Zeiss). The thinned dispersions from the DLS measurements were used to prepare the samples. One drop was placed on a C-pad or a wafer. After air drying, the samples were sputtered with 3 nm Pt.

Preparation of PSt/CB Composites using SteaMA and Different Surfactants

Two different CB types, NIPex® 35 and NIPex® 150 (Evonik) were selected for the preparation of PSt/CB composites. But the invention is not limited to these CB types. NIPex® 35 is a non-oxidized, low structure furnace black with a mean primary particle size of about 31 nm and a pH value of about 9 (according to DIN ISO 787/9). NIPex® 150 is a high structure oxidized gas black with a mean primary particle size of about 25 nm and a pH value of about 4 (according to DIN ISO 787/9). As will be understood by a skilled person, other suitable types of carbon black may also be used.

The procedure described above was repeated using the recipe described in the 2^{nd} part of Table 2 which relates to Example 3. The CB was added to the organic phase at the beginning and the organic phase was shaken. Then water and the surfactant were added to the mixture which was processed as described above.

TABLE 2
Table 2. Recipes for the MEP of styrene using SteaMA as co-stabilizer

| | Water | Styrene | Surfactant | | Co-stabilizer | | AIBN | Filler | | | CCA | |
|---|---|---|---|---|---|---|---|---|---|---|---|---|
| Sample | [g] | [g] | Type | [mg] | Type | [mg] | [mg] | Type | [mg] | wt %^{#} | Type | [mg] |
| 0 (Reference) | 37.7 | 8.6 | SDS | 103 | HD | 359 | 269 | Without | 0 | | without | 0 |
| 1 (Reference) | 41.6 | 4.3 | SDS | 56 | SteaMA | 929 | 146 | Without | 0 | | without | 0 |
| 2 (Reference) | 41.6 | 4.3 | SDS | 52 | SteaMA | 955 | 140 | without | 0 | | without | 0 |
| 3* | 28.09 | 6.4 | SDS | 76 | HD | 264 | 199 | CB150 | 344 | 5.4 | without | 0 |
| (Reference) | | | | | | | | | | | | |
| 4 | 41.6 | 4.3 | SDS | 52 | SteaMA | 979 | 133 | CB150 | 214 | 5.0 | without | 0 |
| 5 | 41.6 | 4.3 | SDS | 52 | SteaMA | 959 | 134 | CB150 | 344 | 8.0 | without | 0 |
| 6 | 41.6 | 4.3 | SDS | 53 | SteaMA | 927 | 135 | CB150 | 345 | 10.0 | without | 0 |
| 8 | 41.6 | 4.3 | SDS | 53 | SteaMA | 934 | 136 | CB150 | 429 | 5.0 | without | 0 |
| 9 | 41.6 | 4.3 | SDS | 52 | SteaMA | 935 | 134 | CB35 | 214 | 5.0 | without | 0 |
| 10 | 41.6 | 4.3 | SDS | 54 | SteaMA | 932 | 137 | CB90 | 215 | 5.0 | without | 0 |
| 11 | 37.7 | 8.6 | SDS | 103 | HD | 356 | 268 | CB150 | 428 | 5.0 | MEC-88 | 86 |
| 12 | 37.7 | 8.6 | SDS | 103 | HD | 357 | 268 | CB150 | 428 | 5.0 | MEC-105 | 86 |
| 13 | 41.6 | 4.3 | SDS | 51 | SteaMA | 926 | 134 | CB150 | 214 | 5.0 | MEC-88 | 467 |
| 14 | 41.6 | 4.3 | SDS | 52 | SteaMA | 926 | 134 | CB150 | 214 | 5.0 | MEC-105 | 429 |

*sonication 20 minutes at 90% duty, polymerization for 6 hours
^{#}based on styrene.

Table 3 below outlines the results for the MEP of St in the presence of SteaMA. Table 4 below outlines the results obtained for PSt/CB composites using HD or SteaMA as co-stabilizer in the presence of CCA. In this invention, bi-salicylates of Al and Zr were used as charge control agents. As will be understood by a skilled person, other suitable charge control agents may also be used.

TABLE 3
Results for the MEP of St in the presence of SteaMA

| | Particle size | | | | | | |
|---|---|---|---|---|---|---|---|
| | DLS | | SEC | | | Conversion | |
| | z-ave | | Mₙ | M_{w} | | rate | Coagulum |
| Example | [nm] | PDI | [g/mol] | [g/mol] | M_{w}/Mₙ | [%] | [%] |
| 0 | 78 | 0.06 | 149000 | 693000 | 4.7 | 94 | 0.3 |
| (Reference) | | | | | | | |
| 1 | 72 | 0.06 | 121000 | 1370000 | 11.3 | 96 | 0.2 |
| (Reference) | | | | | | | |
| 2 | 73 | 0.05 | 105000 | 889000 | 8.5 | 97 | 0.2 |
| (Reference) | | | | | | | |
| 3 | 98 | 0.18 | 105000 | 571000 | 5.4 | 95 | 1.0 |
| (Reference) | | | | | | | |
| 4 | 92 | — | 96000 | 1375000 | 14.3 | 96 | 0.2 |
| 6 | 100 | — | 169000 | 1820000 | 10.8 | 94 | 1.6 |
| 8 | 103 | — | 157000 | 1690000 | 10.8 | 93 | 1.6 |
| 9 | 96 | — | 178000 | 1870000 | 10.5 | 96 | 0.7 |
| 10 | 90 | — | 148000 | 1675000 | 11.3 | 93 | 2.1 |

TABLE 4
Results obtained for PSt/CB composites using HD or SteaMA as
co-stabilizer in the presence of CCA

| | Particle | | | | | | |
|---|---|---|---|---|---|---|---|
| | size | | | | | | |
| | DLS | | SEC | | | Conversion | Coag- |
| | z-ave | | Mₙ | M_{w} | | rate | ulum |
| | [nm] | PDI | [g/mol] | [g/mol] | M_{w}/Mₙ | [%] | [%] |
| 11 | 109^{a} | — | 115000 | 517000 | 4.5 | 96 | 2.4 |
| 12 | 103^{a} | — | 115000 | 473000 | 4.1 | 96 | 0.6 |
| 13 | 94^{b} | — | 145000 | 1633000 | 11.3 | 104 | 0.7 |
| 14 | 118^{b} | — | 109000 | 1677000 | 15.4 | 97 | 0.1 |

^{a}Unmodified CB and larger agglomerates could be observed by SEM.
^{b}Unmodified, non-encapsulated CB could not be identified by SEM. Few agglomerates in of about 200 nm were observed.

Description of the SEM Images of Particles Obtained with the SteaMA

### Preparation of the Samples for SEM Measurements

After the polymerization, a part of the resultant dispersion was thinned with 0.01 normal NaCl solution in deionized water (200-250 mg dispersion were thinned with 10 g of NaCl solution). These thinned dispersions were used for the particle size measurements as well as for the SEM investigations. The SEM investigations were performed with an Ultra 55 plus (Zeiss). The thinned dispersions from the DLS measurements were used to prepare the samples. One drop was placed on a purified silicon wafer mounted at a sample holder. After air drying, the samples were sputtered with 3 nm Pt. FIG. 1 and FIG. 2 show representative images for the sample prepared. The pictures show the particles of PSt/CB composites (5 and 8 wt % PRINTex® 150) which were obtained by the MEP of St in the presence of CB. Stearyl methacrylate (SteaMA) was used as co-stabilizer instead of the often used hexadecane (HD). No unmodified CB was detected by the SEM measurements.

Although the present embodiments have been described with reference to specific example embodiments, it will be evident that various modifications and changes may be made to these embodiments without departing from the broader spirit and scope of the various embodiments. The present disclosure refers to a number of documents, the content of which is herein incorporated by reference in their entirety.

### INDUSTRIAL APPLICABILITY

The polymer/carbon black composite material of the invention may be used in various applications. Such applications include for example toner applications. In these applications, the composite material of the invention leads to a reduction in the volatile organic content (VOC). Accordingly, the polymer/carbon black composite material of the invention is environmentally friendly and potentially less harmful for the health. The polymer/carbon black composite material of the invention may also be useful in applications where it is desired to have a material with a low T_{g}.

It will be appreciated that the polymer/carbon black composite material, toners comprising such material, use of the material and the toners, and processes for preparing the material and the toners disclosed herein may be embodied in various combinations to produce environmentally friendly and cost efficient toners. Accordingly, the specification and drawings are to be regarded in an illustrative rather than a restrictive sense.

What is claimed is:

1. A process for preparing a polymer/carbon black composite material, comprising a mini emulsion polymerization (MEP) process involving a reactive co-stabilizer.

2. The process according to claim 1, wherein the co-stabilizer is a long alkyl chain methacrylate or a mixture of long alkyl chain methacrylates.

3. The process according to claim 1, wherein the co-stabilizer is a long alkyl chain methacrylate of general formula I below 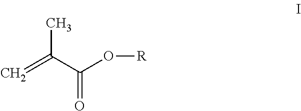
wherein R is a C₆ to C₂₂ linear, branched, saturated or unsaturated alkyl group, or the co-stabilizer is a mixture of two or more of the long alkyl chain methacrylates.

4. The process according to claim 1, wherein the co-stabilizer is a long alkyl chain methacrylate of general formula I below 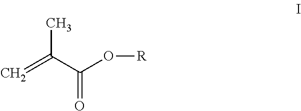
wherein R is a C₁₀ to C₂₀ linear, branched, saturated or unsaturated alkyl group, or the co-stabilizer is a mixture of two or more of the long alkyl chain methacrylates.

5. The process according to claim 1, wherein the co-stabilizer is stearyl methacrylate (SteaMA) of formula II below

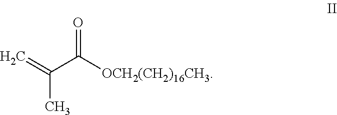

6. The process according to claim 1, wherein the MEP process further involves monomers of one type or more and carbon black.

7. The process according to claim 1, wherein the MEP process further involves monomers of one type or more, carbon black and a charge control agent.

8. The process according to claim 1, wherein the MEP process further involves monomers of one type or more and carbon black, and wherein the monomers are selected from the group consisting of styrene (St), alkyl esters of acrylic and methacrylic acids, vinyl esters of aliphatic acids, and monomers containing sulfonate groups including sodium styrene sulfonate (NaSS).

9. The process according to claim 1, wherein the MEP process further involves styrene (St) monomers and carbon black.

10. The process according to claim 1, wherein the MEP process further involves styrene (St) monomers, carbon black and a charge control agent.

11. The process according to claim 1, wherein the amount of co-stabilizer is about 0.5 to 15 mol % based on the amount of the monomers.

12. The process according to claim 1, wherein the MEP process further involves monomers of one type or more, carbon black and a charge control agent, and wherein an amount of the charge control agent is about 0.1 to 10 mol % based on the amount of the monomers.

13. A polymer/carbon black composite material obtained by a mini emulsion polymerization process (MEP) involving:
a co-stabilizer which is a long alkyl chain methacrylate of general formula I below 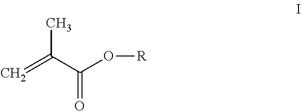
wherein R is a C₆ to C₂₂ linear, branched, saturated or unsaturated alkyl group, or the co-stabilizer is a mixture of two or more of the long alkyl chain methacrylates;
monomers of one type or more; and
carbon black.

14. The polymer/carbon black composite material according to claim 13, further involving a charge control agent.

14. The polymer/carbon black composite material according to claim 13, having particles size in the range of about 20 to 1000 nm.

15. The polymer/carbon black composite material according to claim 13, having a carbon black content in the range of about 0.5 to 20 wt %.

16. A polystyrene/carbon black or polystyrene copolymer/carbon black obtained by a mini emulsion polymerization process (MEP) involving styrene (St) monomers, stearyl methacrylate (SteaMA) of general formula II below, and a charge control agent [chemical structure]
